(19) United States
(12) Patent Application Publication
(10) Pub. No.: US 2010/0240508 A1
(43) Pub. Date: Sep. 23, 2010

(54) PORTABLE ARTICLE WITH INDICIA THEREON TO FACILITATE PERFORMING AN EXERCISE

(76) Inventor: Gasper Guarrasi, Long Beach, CA (US)

Correspondence Address: CHARTER IP, LLC, P.O. BOX 64, The Plains, VA, 20198, US

(21) Appl. No.: 12/790,805

(22) Filed: May 29, 2010

Related U.S. Application Data
(63) Continuation of application No. PCT/US2009/069363, filed on Dec. 23, 2009.
(60) Provisional application No. 61/140,564, filed on Dec. 23, 2008.
(60) Provisional application No. 61/164,189, filed on Mar. 27, 2009.
(60) Provisional application No. 61/170,746, filed on Apr. 20, 2009.

(51) Int. Cl. A63B 26/00; F16M 13/00

(52) U.S. Cl. 482/142; 248/346.01; 40/299.01

(57) ABSTRACT

A portable article with indicia displayed thereon for use in exercising includes a structure, the structure having a surface, the surface including a plurality of different exercises visibly displayed thereon. The indicia may be displayed on the surface beneath each of the different exercises to facilitate exercise.

### PRIORITY STATEMENT

This application is a continuation of and claims the benefit under 35 U.S.C. §365(c) (in accordance with section §120) to PCT International Application Serial No. PCT/US2009/069363, filed Dec. 23, 2009, which in turn claims the benefit under 35 U.S.C. 119(e) of U.S. Provisional Patent Application Nos. 61/140,564, filed Dec. 23, 2008, 61/164,189, filed Mar. 27, 2009, and 61/170,746, filed Apr. 20, 2009. The entire contents of each of these applications are hereby incorporated by reference herein.

### BACKGROUND

1. Field

Example embodiments in general relate to portable articles having indicia displayed thereon to facilitate performing exercise and/or stretching routines.

2. Related Art

Providing a comfortable surface for exercise is an important part of preventing injury and strain to the exerciser. In one example, exercisers that are stretching or using the body's own weight as resistance during exercise use a flat mat that is about as long as the average person is tall and is slightly wider than the width of the average person's shoulders. The mat is placed on the ground and the user stands, sits, kneels or lies on the mat depending on what the exercise or stretch requires. If the exerciser desires a soft surface, a thicker and more padded mat is used.

In another example, an exerciser may use a fitness ball to provide a fun, safe, interactive, and challenging surface for use. The typical fitness ball is available in any color, various sizes, and is made out of plastic or rubber. After the ball is inflated to a desired firmness, a user may sit, lay, kneel, hold, rest on, or otherwise engage the ball to perform numerous stretches and exercises.

To ensure that a consistent, safe, and useful exercise program is followed, the exerciser frequently uses a pre-planned exercise routine that is diagrammed on a pamphlet or poster. If the exerciser is using a poster, he/she must perform the exercise routine next to a wall that can hold the poster. If the exerciser is using a pamphlet, he/she must make sure to bring the pamphlet to where ever the exercise is being performed. Because exercising against a wall may be inconvenient and pamphlets may become lost or forgotten, what is needed is a diagrammed stretching or exercise routine that will conveniently travel with the exerciser wherever the exercises are performed. Moreover, items that conveniently travel with the exerciser include a foldable or roll able exercise mat, as well as a portable, inflatable exercise ball.

Millions of people work in office environments or have home-offices. The typical workspace for an office worker includes a computer with a detectable keyboard and/or a detachable mouse. The office furniture may be made from anything ranging from luxurious wood to inexpensive plastic. Typically, the surfaces of office furniture are not conducive to the operation of the mouse. Specifically, a trackball mouse may not appropriately grip and roll on slick surfaces, and an optical mouse may not operate with an overly reflective or light scattering surface. As such, the typical office workstation includes a mouse pad that rests under the mouse to facilitate effective operation of the mouse.

Office workers frequently sit at their desks for long periods of time all the while using the computer keyboard and mouse to work on a computer. The tedious mouse and keyboard work done by office workers frequently results in stiff and aching fingers, wrists, forearms, shoulders, and neck. Although office spaces may have posters in the break rooms that detail stretches that the office workers can do to alleviate stiffness, such instruction would be much more useful if it were in each work space.

### SUMMARY

An example embodiment of the present invention is directed to a portable article with indicia displayed thereon for use in exercising. The article includes a structure, the structure having a surface, the surface including a plurality of different exercises visibly displayed thereon. The indicia may be displayed on the surface beneath each of the different exercises to facilitate exercise. The displayed indicia include text related to a name of each of the exercises and a time period to perform one or more of the exercises.

Another example embodiment is directed to a portable article with a structure, the structure having a surface, and the surface including a plurality of different exercises visibly displayed thereon. The indicia may be displayed on the surface beneath each of the different exercises to facilitate exercise. The displayed indicia include text related to a name of each of the exercises. One or more of the exercises further includes text related to a number of repetitions to perform.

Another example embodiment is directed to a fitness mat for use in performing an exercise. The fitness mat includes a mat of a generally flat structure having a top surface, bottom surface and a thickness, a major longitudinal axis and a minor longitudinal axis orthogonal to the major longitudinal axis. One of the top and bottom surfaces includes a plurality of different exercises visibly displayed thereon embodied by human figurines demonstrating how to perform the exercises. Indicia may be displayed beneath each of the human figurines. The displayed indicia include text related to a name of each of the exercises and a time period to perform one or more of the exercises.

Another example embodiment is directed to a fitness of a generally flat structure having a top surface, bottom surface, thickness, major longitudinal axis, and a minor longitudinal axis orthogonal to the major longitudinal axis. One of the top and bottom surfaces includes a plurality of different exercises visibly displayed thereon embodied by human figurines demonstrating how to perform the exercises. Indicia may be displayed beneath each of the human figurines. The displayed indicia include text related to a name of each of the exercises. One or more of the exercises further including text related to a number of repetitions to perform.

Another example embodiment is directed to a fitness ball comprising an inflatable ball of a spherical shape having an outer surface, with an outer surface having a plurality of different exercises visibly displayed thereon and embodied by human figurines demonstrating how to perform the exercises. Indicia may be displayed beneath each of the human figurines. The displayed indicia include text related to a name of each of the exercises and a time period to perform one or more of the exercises.

Another example embodiment is directed to a fitness ball comprising an inflatable ball of a spherical shape having an outer surface, with an outer surface having a plurality of different exercises visibly displayed thereon and embodied by human figurines demonstrating how to perform the exercises. Indicia may be displayed beneath each of the human figurines, to include text related to a name of each of the exercises. One or more of the exercises further include text related to a number of repetitions to perform.

Another example embodiment is directed to a mouse pad for use in performing an exercise. The mouse pad includes a pad of a generally flat, square structure having a top surface and bottom surface. One of the top and bottom surfaces includes a plurality of different exercises visibly displayed thereon embodied by human figurines demonstrating how to perform the exercises.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a top plan view of a fitness mat having a general stretch fitness program displayed thereon in accordance with an example embodiment of the present invention.

FIG. 2 is a cross-sectional view taken along line A-A′ in FIG. 1.

FIG. 3 is a cross-sectional view taken along line B-B′ in FIG. 1.

FIG. 4 is an enlarged view of the dotted-line box C in FIG. 1.

FIG. 5 is a top plan view of a fitness mat having a back stretch fitness program displayed thereon in accordance with another example embodiment.

FIG. 6 is a top plan view of a fitness mat having a golf stretch fitness program displayed thereon in accordance with another example embodiment.

FIG. 7 is a top plan view of a fitness mat having a yoga pose fitness program displayed thereon (male character) in accordance with another example embodiment.

FIG. 8 is a top plan view of a fitness mat having a yoga pose fitness program displayed thereon (female character) in accordance with another example embodiment.

FIG. 9 is a top plan view of a fitness mat having a children's yoga pose fitness program displayed thereon in accordance with another example embodiment.

FIG. 10 is a top plan view of a fitness mat having a Pilates personal exercise fitness program displayed thereon in accordance with another example embodiment.

FIG. 11 is a top plan view of a fitness mat having a maternity stretch fitness program displayed thereon in accordance with another example embodiment.

FIGS. 12 to 14 are side elevation views of a fitness ball having a fitness program displayed thereon in accordance with another example embodiment.

FIG. 15 is a top plan view of a mouse pad having a stretch program displayed thereon in accordance with another example embodiment.

FIG. 16 is a top plan view of a training towel having a general stretch program displayed thereon in accordance with another example embodiment.

### DETAILED DESCRIPTION

As to be set forth more fully below, the example embodiments in general are directed to portable articles having indicia displayed thereon to facilitate performing exercises. As to be described in the various example embodiments, the article includes a structure having a surface, with the surface including a plurality of different exercises visibly displayed thereon. The term exercise as used hereafter may be embodied as any of a physical exercise, stretching pose and yoga pose, for example. As to be shown in further detail hereafter, the indicia on the article surface may include one or more of a display of the exercise, text indicating a number of repetitions to be performed for a given exercise, text indicating an amount of time to perform a given exercise, and the name of the exercise

The structure may be embodied as any of a fitness mat, a fitness ball, a mouse pad and a towel. However, the structure comprising the portable article is not limited to the aforementioned example embodiments, as the above-noted indicia may be applied to a surface of another structure for facilitating exercise.

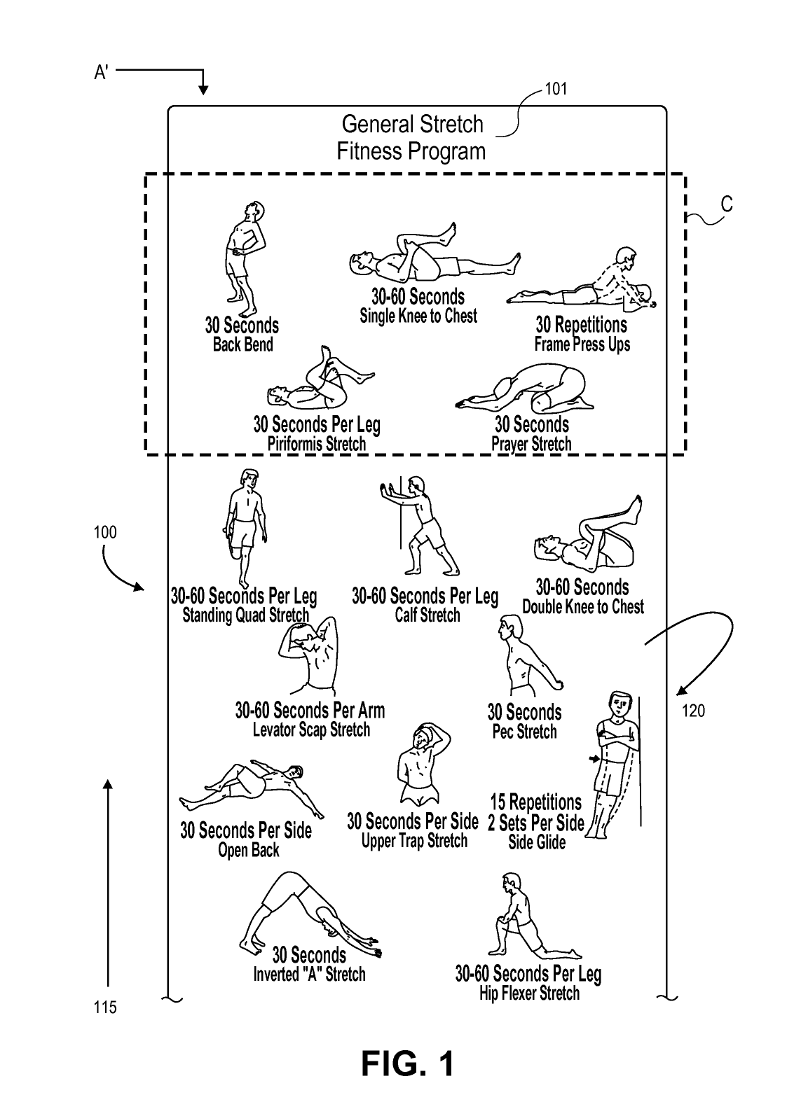

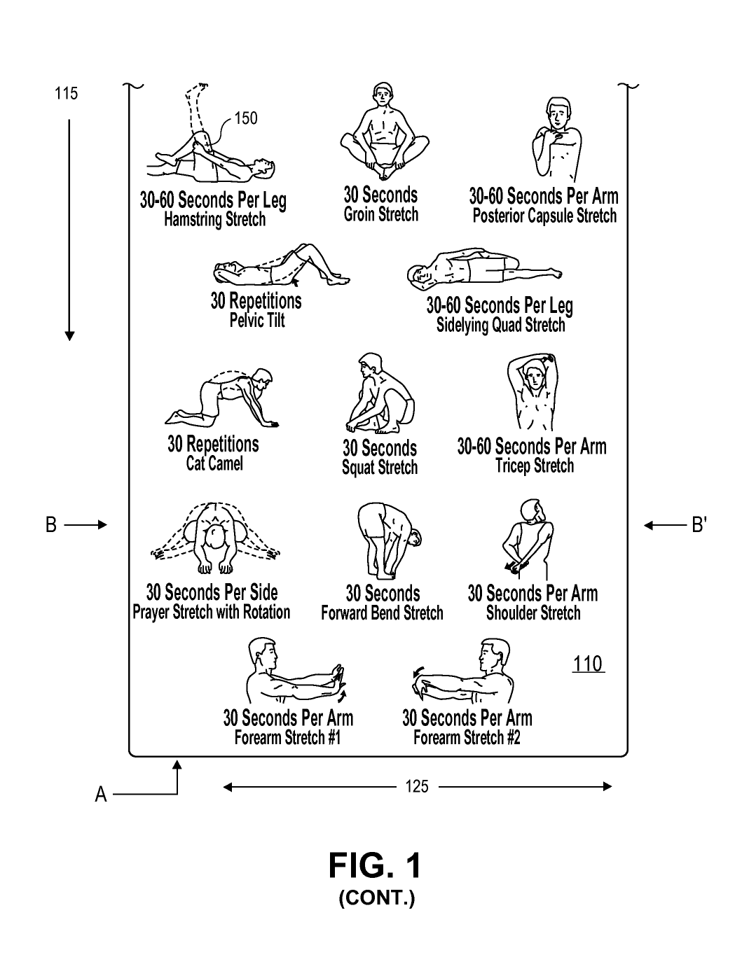

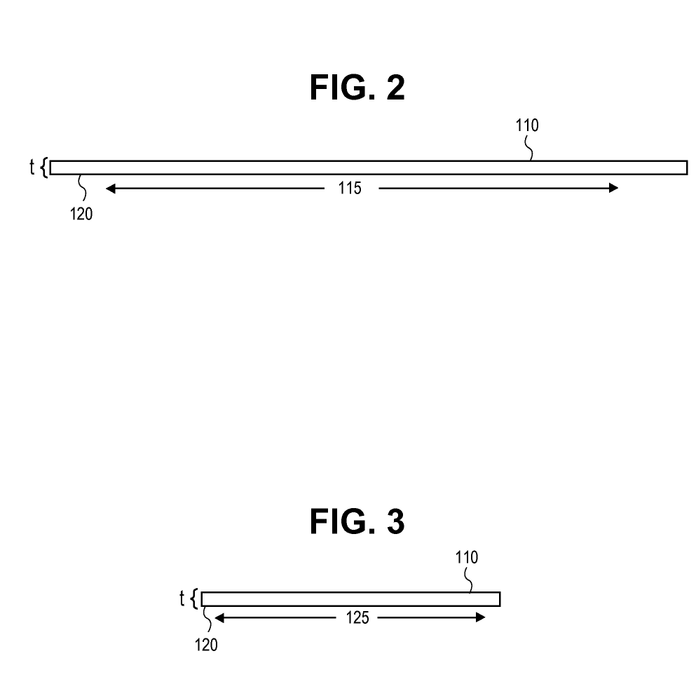

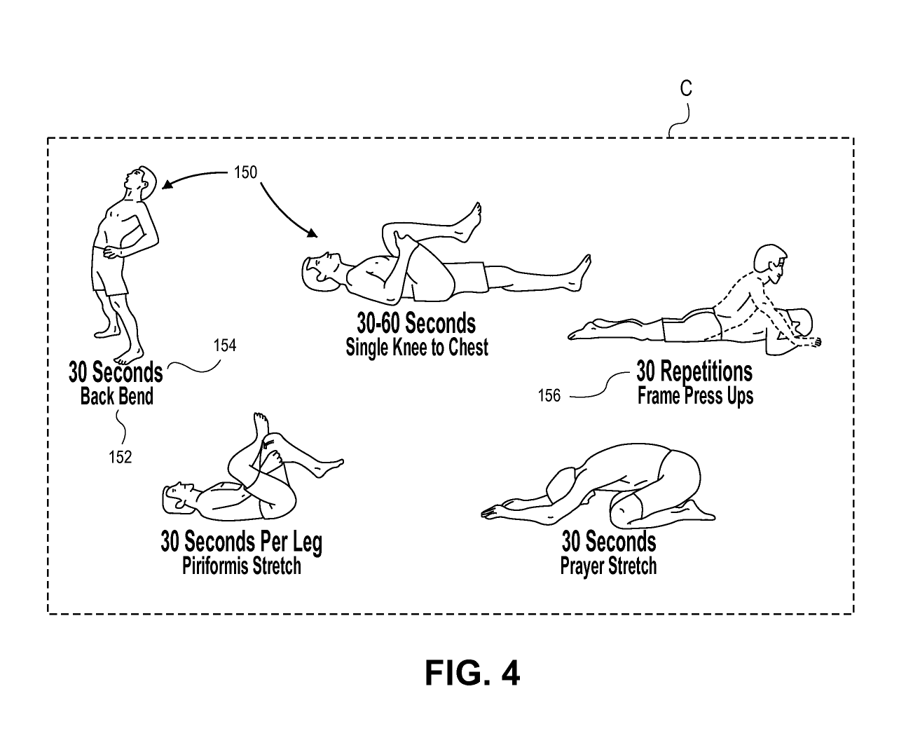

FIG. 1 is a top plan view of a fitness mat having a general stretch fitness program displayed thereon in accordance with an example embodiment of the present invention; FIG. 2 is a cross-sectional view taken along line A-A′ in FIG. 1; FIG. 3 is a cross-sectional view taken along line B-B′ in FIG. 1; and FIG. 4 is an enlarged view of the dotted-line box C in FIG. 1. Referring to FIGS. 1-4, the fitness mat 100 includes a generally rectangular mat 100 having a generally flat structure with a plurality of indicia and/or markings thereon to facilitate performance of various exercises and/or stretch routines. The mat 100 has an upper or top surface 110 and a lower or bottom surface 120.

In an example, the fitness mat 100 is rollable or foldable and can be fabricated from a suitable foam rubber such as ethylene vinyl acetate (EVA) foam. The EVA foam may include an antimicrobial agent therein or can include a thin antimicrobial material adhered to on a surface thereof, for example. Additional example materials for mat 100 may be any material used in commercially available anti-fatigue exercise mat products.

The mat 100 has a major longitudinal axis (“major axis 115”), a minor longitudinal axis (“minor axis 125”) orthogonal to the major axis 115, and a thickness “t. The mat 100 of FIGS. 1-4 includes indicia, particularly a plurality of different exercises 150 displayed in series format to represent a general stretch fitness program 101. Although exercises 150 are shown only on top surface 110, the exercises 150 and associated indicia/markings may be displayed or printed additionally on bottom surface 120, or only on bottom surface 120, for example.

As shown in the enlarged view C of FIG. 4, each exercise includes explanatory indicia or text underneath the exercise. In one example, the displayed exercise includes indicia or text 152 related to the name of the exercise (i.e., “Back Bend”). In another example, the displayed exercise includes indicia or text 154 related to the amount of time to perform the exercise (i.e., “30 Seconds”). In a further example, the displayed exercise includes indicia or text 156 related to the number of repetitions to perform the exercise (i.e., “30 Repetitions”). In some examples, the exercise 150 is accompanied by name text 152 and repetition text 156; in other examples the exercise 150 is accompanied by name text 152 and time text 154. As will be seen in additional example embodiments, the exercise 150 is accompanied by each of name text 152, time text 154 and repetition text 156. The following Table 1 details the various exercises, timing and repetitions displayed on mat 100 as shown in FIG. 1; it being understood that such are only exemplary of various possible exercises which could be incorporated into the example general stretch fitness program 101.

TABLE 1
GwENERAL STRETCH FITNESS PROGRAM

| Exercise Name | Time | | Repetitions |
|---|---|---|---|
| Back Bend | 30 | seconds | |
| Single Knee to Chest | 30-60 | seconds | |
| Prone Press Ups | | | 30 |
| Piriformis Stretch | 30-60 | seconds | per leg |
| Prayer Stretch | 30 | seconds | |
| Standing Quad Stretch | 30-60 | seconds | per leg |
| Calf Stretch | 30-60 | seconds | per leg |
| Double Knee to Chest | 30-60 | seconds | |
| Levator Scap Stretch | 30-60 | seconds | per arm |
| Pec Stretch | 30 | seconds | |
| Open Book | 30-60 | seconds | per side |
| Upper Trap Stretch | 30 | seconds | per side |
| Side Glide | | | 15, 2 sets per side |
| Inverted “V” Stretch | 30 | seconds | |
| Hip Flexor Stretch | 30-60 | seconds | per leg |
| Hamstring Stretch | 30-60 | seconds | per leg |
| Groin Stretch | 30 | seconds | |
| Posterior Capsule Stretch | 30-60 | seconds | per arm |
| Pelvic Tilt | | | 30 |
| Sidelying Quad Stretch | 30-60 | seconds | per leg |
| Cat Camel | | | 30 |
| Squat Stretch | | | 30 |
| Tricep Stretch | 30-60 | seconds | per arm |
| Prayer Stretch with Rotation | 30 | seconds | per side |
| Forward Bend Stretch | 30 | seconds | |
| Shoulder Stretch | 30 | seconds | per arm |
| Forearm Stretch #1 | 30 | seconds | per arm |
| Forearm Stretch #2 | 30 | seconds | per arm |

The fitness mat 100 may be manufactured in various colors in both male and female figurines, as desired. Although FIG. 1 shows a fitness mat 100 that displays specific movements with desired repetitions and durations of movement, the fitness mat 100 may display any number of movements, repetitions, or durations without deviating from the example embodiments. The indicia (inclusive of exercise figurines and text) may be printed on the fitness mat 100 by any means within the skill of the art.

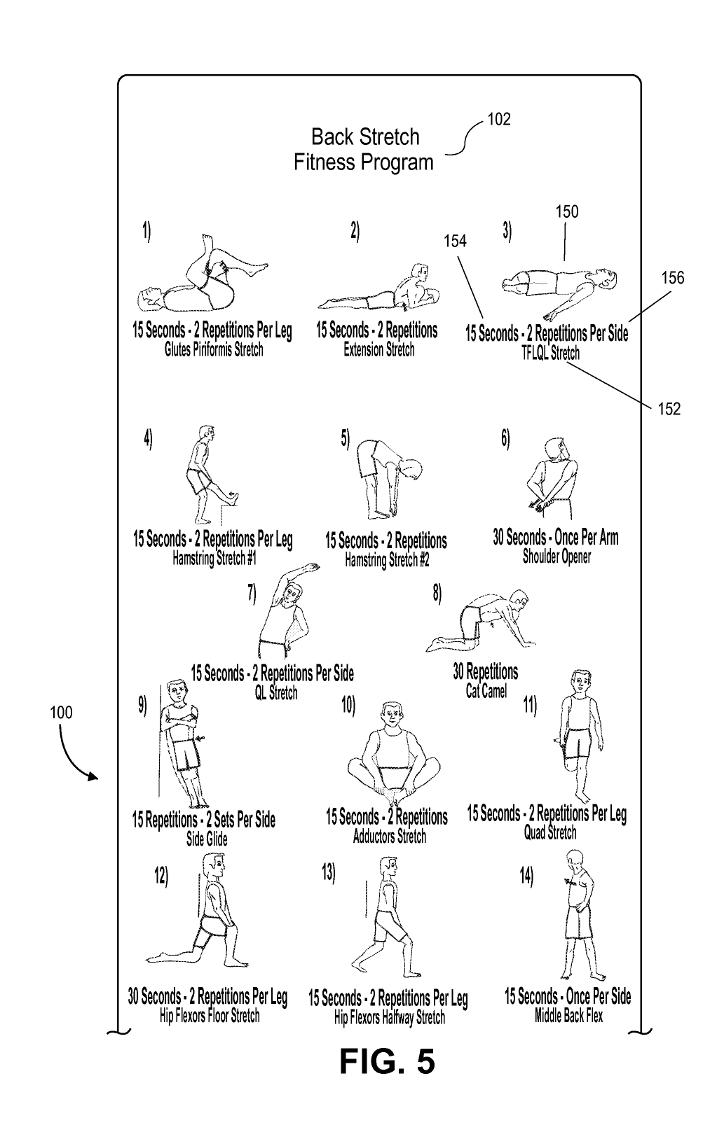

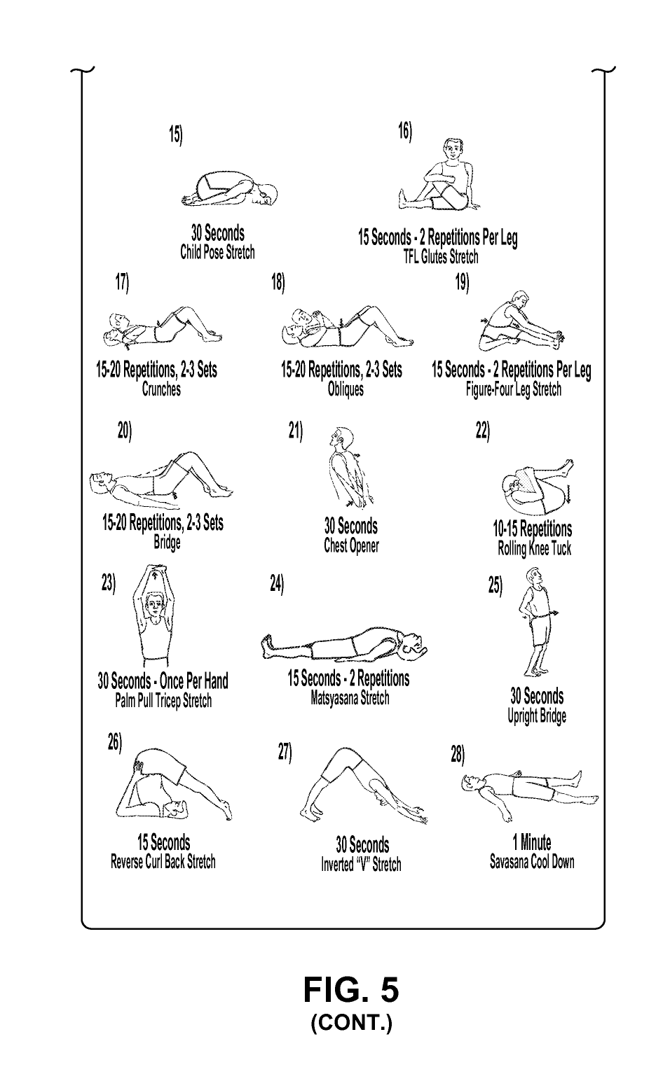

FIG. 5 is a top plan view of a fitness mat having a back stretch fitness program displayed thereon in accordance with another example embodiment. As the structural characteristics of fitness mat 100 as described in FIGS. 1-4 are substantially identical to FIG. 5, only the differences are discussed in detail. Referring to FIG. 5, there is shown a plurality of different exercises 150 displayed on fitness mat 100 in series as a back stretch fitness program 102. Here, one or more exercises 150 are accompanied by each of name text 152, time text 154 and repetition text 156.

The following Table 2 details the various exercises, timing and repetitions displayed on mat 100 as shown in FIG. 5; it being understood that such are only exemplary of various possible exercises which could be incorporated into the example back stretch fitness program 102.

TABLE 2
BACK STRETCH FITNESS PROGRAM

| Exercise Name | Time | Repetitions |
|---|---|---|
| Glutes Piriformis Stretch | 15 seconds | 2 per leg |
| Extension Stretch | 15 seconds | 2 |
| TFLQL stretch | 15 seconds | 2 per side |
| Hamstring Stretch #1 | 15 seconds | 2 per leg |
| Hamstring Stretch #2 | 15 seconds | 2 |
| Shoulder Opener | 30 seconds | Once per arm |
| QL Stretch | 15 seconds | 2 per side |
| Cat Camel | | 30 |
| Side Glide | | 15, 2 sets per side |
| Adductors Stretch | 15 seconds | 2 |
| Quad Stretch | 15 seconds | 2 per leg |
| Hip Flexors Floor Stretch | 30 seconds | 2 per leg |
| Hip Flexors Halfway Stretch | 15 seconds | 2 per leg |
| Middle Back Flex | 15 seconds | Once per side |
| Child Pose Stretch | 30 seconds | |
| TFL Glutes Stretch | 15 seconds | 2 per leg |
| Crunches | | 15-20, 2-3 sets |
| Obliques | | 15-20, 2-3 sets |
| Figure-Four Leg Stretch | 15 seconds | 2 per leg |
| Bridge | | 15-20, 2-3 sets |
| Chest Opener | 30 seconds | |
| Rolling Knee Tuck | | 10-15 |
| Palm Pull Tricep Stretch | 30 seconds | Once per hand |
| Matsyasana Stretch | 15 seconds | 2 |
| Upright Bridge | 30 seconds | |
| Reverse Curl Back Stretch | 15 seconds | |
| Inverted “V” Stretch | 30 seconds | |
| Savasana Cool Down | 1 minute | |

Similar to FIG. 1, although exercises 150 are shown only on one surface, the exercises 150 and associated indicia/markings may be displayed on either or both surfaces. Moreover, different fitness programs may be displayed on either side of the fitness mat, i.e., the general stretch fitness program 101 may be displayed on one surface of mat 100 and back stretch fitness program 102 on the reverse surface for example.

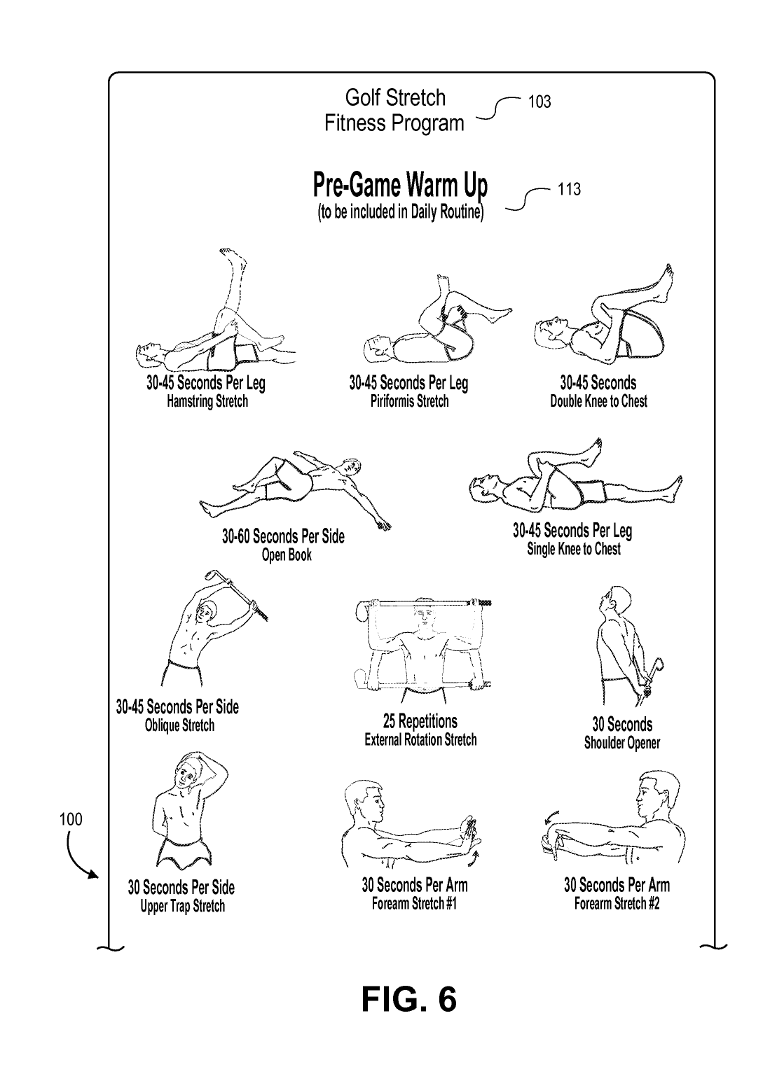

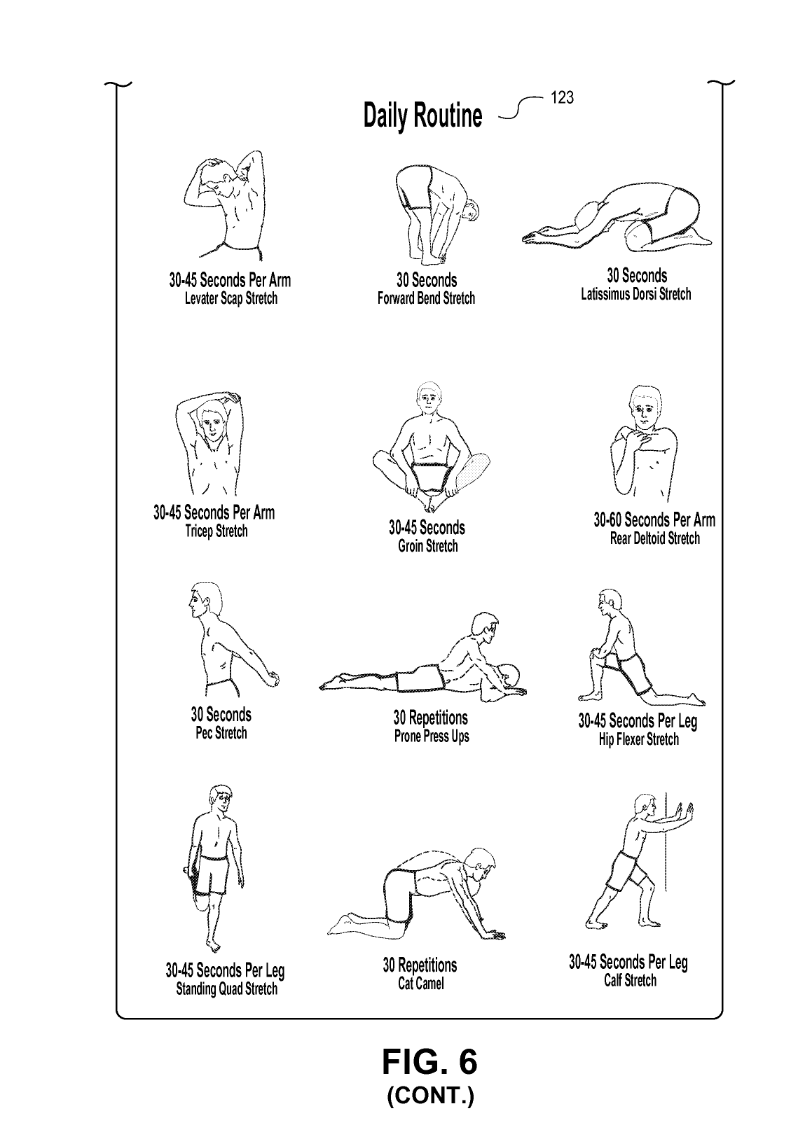

FIG. 6 is a top plan view of a fitness mat having a golf stretch fitness program displayed thereon in accordance with another example embodiment. As the structural characteristics of fitness mat 100 as described in FIGS. 1-4 are substantially identical to FIG. 6, only the differences are discussed in detail. Referring to FIG. 6, there is shown a plurality of different exercises 150 displayed on fitness mat 100 in series as a golf stretch fitness program 103. However, fitness mat 100 includes two (2) separate fitness programs or routines, a “Pre-Game Warm Up” 113 and a “Daily Routine” 123. Tables 3 and 4 below detail the various exercises, timing and repetitions displayed in the Pre-Game Warm Up 113 and Daily Routine 123 fitness programs as shown in FIG. 6; it being understood that such are only exemplary of various possible exercises which could be incorporated into the golf stretch fitness program 103.

TABLE 3
PRE-GAME WARM UP

| Exercise Name | Time | | Repetitions |
|---|---|---|---|
| Hamstring Stretch | 30-45 | seconds | per leg |
| Piriformis Stretch | 30-45 | seconds | per leg |
| Double Knee to Chest | 30-45 | seconds | |
| Open Book | 30-60 | seconds | per side |
| Single Knee to Chest | 30-45 | seconds | per leg |
| Oblique Stretch | 30-45 | seconds | per side |
| External Rotation Stretch | | | 25 |
| Shoulder Opener | 30 | seconds | |
| Upper Trap Stretch | 30 | seconds | per side |
| Forearm Stretch #1 | 30 | seconds | per arm |
| Forearm Stretch #2 | 30 | seconds | per arm |

TABLE 4
DAILY ROUTINE

| Exercise Name | Time | | Repetitions |
|---|---|---|---|
| Levator Scap Stretch | 30-45 | seconds | per arm |
| Forward Bend Stretch | 30 | seconds | |
| Latissimus Dorsi Stretch | 30 | seconds | |
| Tricep Stretch | 30-45 | seconds | per arm |
| Groin Stretch | 30-45 | seconds | |
| Rear Deltoid Stretch | 30-60 | seconds | per arm |
| Pec Stretch | 30 | seconds | |
| Prone Press Ups | | | 30 |
| Hip Flexor Stretch | 30-45 | seconds | per leg |
| Standing Quad Stretch | 30-45 | seconds | per leg |
| Cat Camel | | | 30 |
| Calf Stretch | 30-45 | seconds | per leg |

As in the previous example embodiments, the exercises 150 and associated indicia/markings may be displayed on either or both surfaces, and the golf stretch fitness program 103 can be displayed on mat 100 in conjunction with one or more of the previous fitness programs.

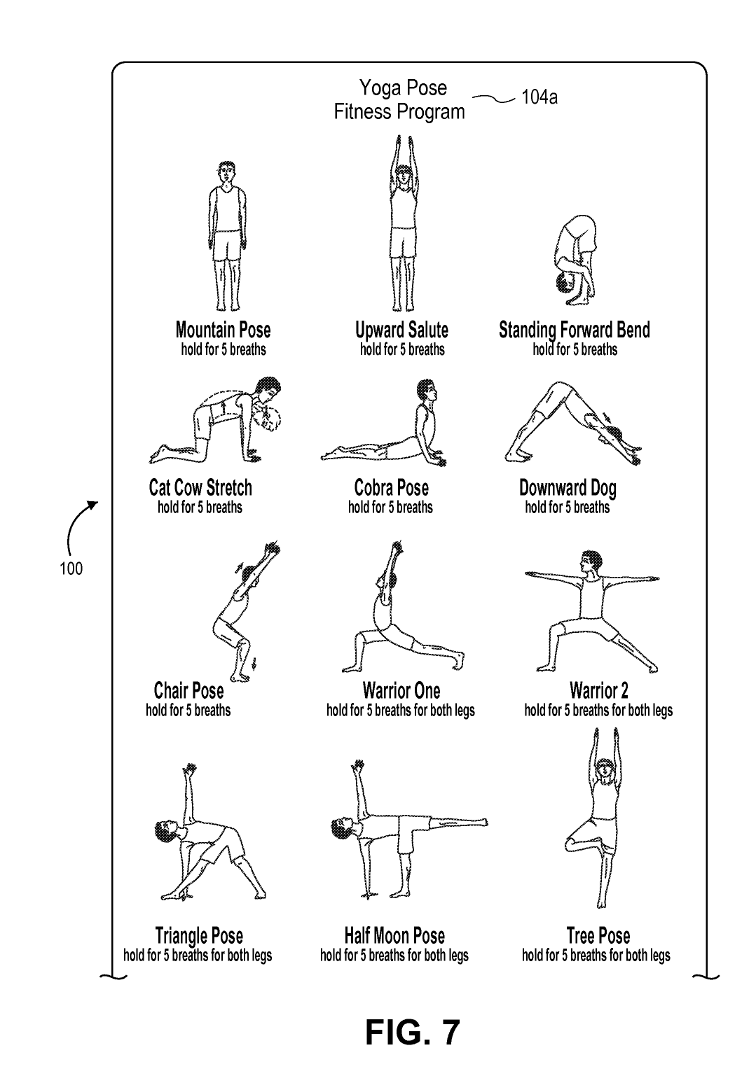

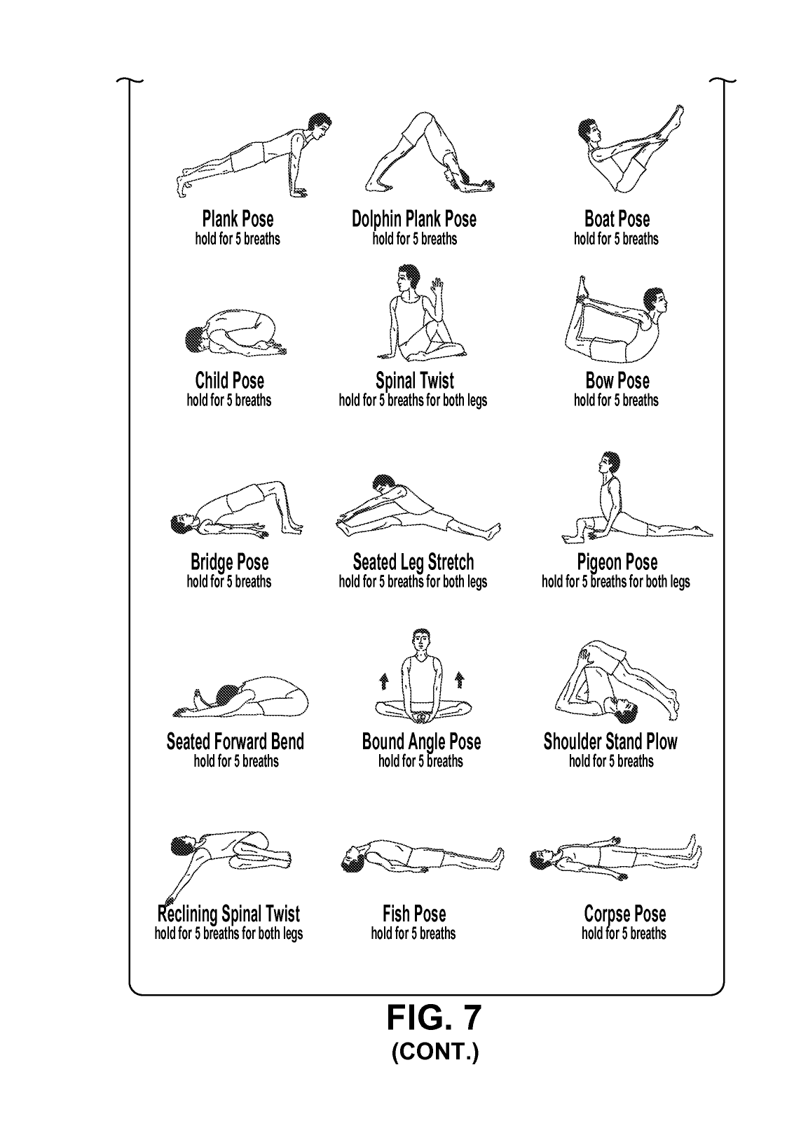

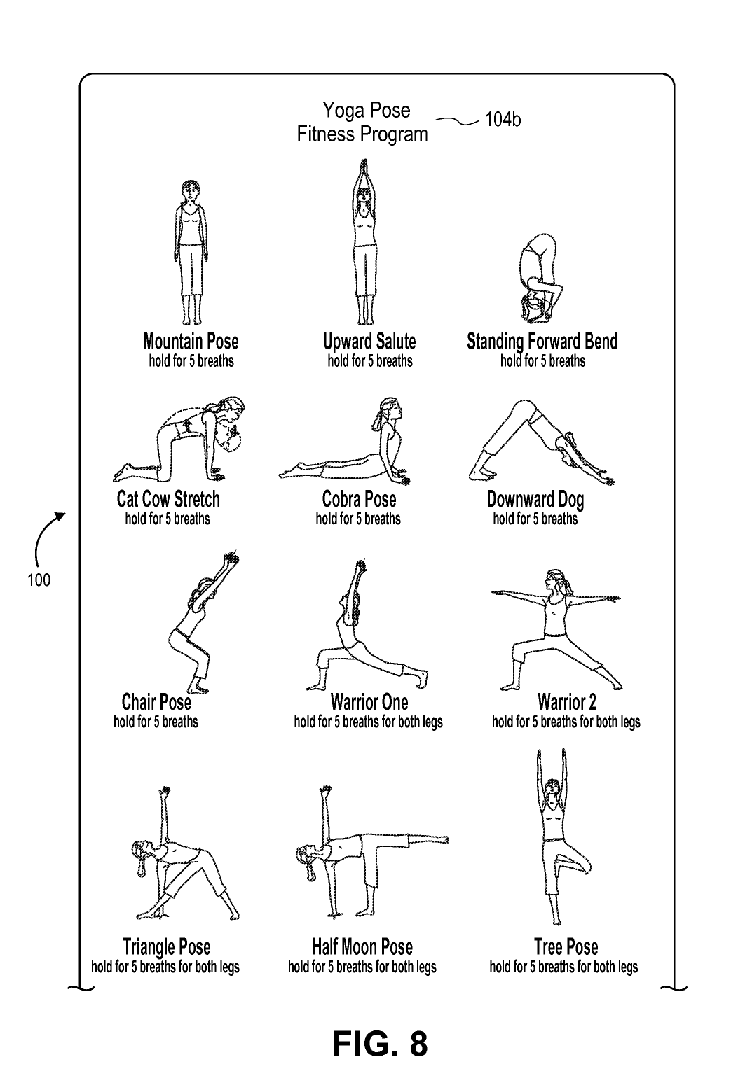

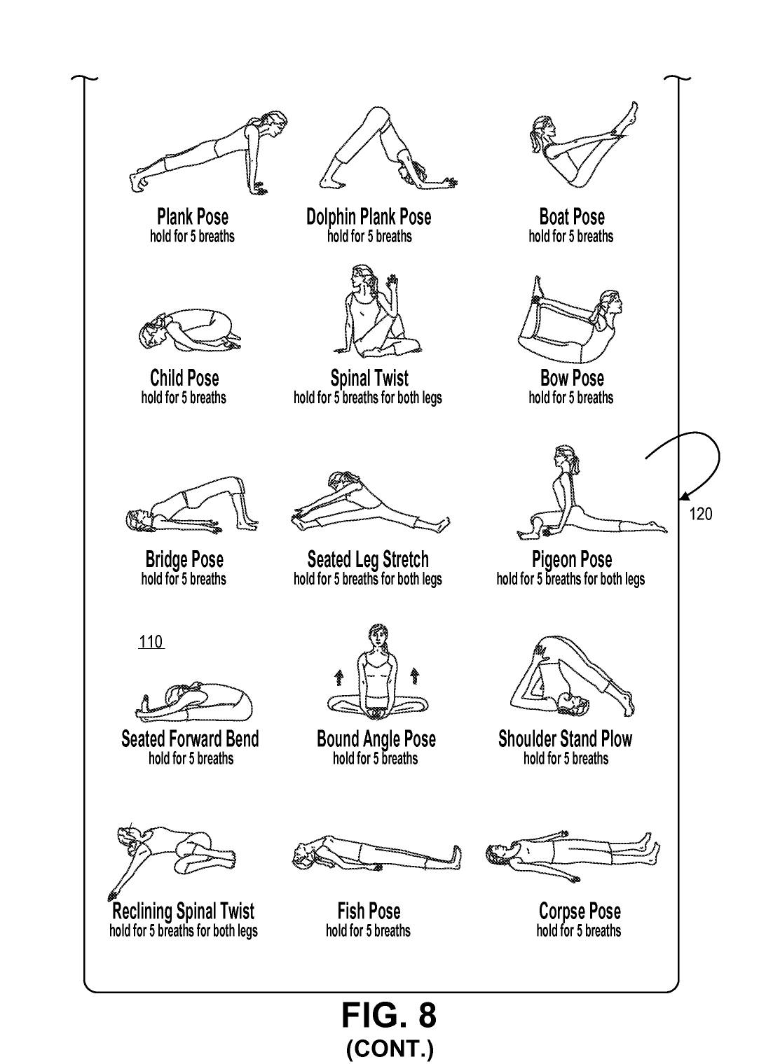

FIG. 7 is a top plan view of a fitness mat having a yoga pose fitness program displayed thereon (male character) in accordance with another example embodiment, and FIG. 8 is a top plan view of a fitness mat having a yoga pose fitness program displayed thereon (female character) in accordance with another example embodiment. FIGS. 7 and 8 are provided to illustrate the use of male and female figurines for exercises 150 in the same fitness program, shown as yoga pose fitness programs 104a, 104b. Similar to the previous embodiments, a given displayed exercise 150 includes associated name text 152 and repetition text 156 (given as a number of breaths).

Table 5 details the various exercises, timing and repetitions displayed in the yoga pose fitness programs 104a, 104b as shown in FIGS. 7 and 8; it being understood that such are only exemplary of various possible exercises which could be incorporated therein.

TABLE 5
YOGA POSE FITNESS PROGRAM

| Exercise Name | Time | Repetitions |
|---|---|---|
| Mountain Pose | Hold for 5 breaths | |
| Upward Salute | Hold for 5 breaths | |
| Standing Forward Bend | Hold for 5 breaths | |
| Cat Cow Stretch | Hold for 5 breaths | |
| Cobra Pose | Hold for 5 breaths | |
| Downward Dog | Hold for 5 breaths | |
| Chair Pose | Hold for 5 breaths | |
| Warrior One | Hold for 5 breaths | Both legs |
| Warrior Two | Hold for 5 breaths | Both legs |
| Triangle Pose | Hold for 5 breaths | Both legs |
| Half Moon Pose | Hold for 5 breaths | Both legs |
| Tree Pose | Hold for 5 breaths | Both legs |
| Plank Pose | Hold for 5 breaths | |
| Dolphin Plank Pose | Hold for 5 breaths | |
| Boat Pose | Hold for 5 breaths | |
| Child Pose | Hold for 5 breaths | |
| Spinal Twist | Hold for 5 breaths | |
| Bow Pose | Hold for 5 breaths | |
| Bridge Pose | Hold for 5 breaths | |
| Seated Leg Stretch | Hold for 5 breaths | Both legs |
| Pigeon Pose | Hold for 5 breaths | Both legs |
| Seated Forward Bend | Hold for 5 breaths | |
| Bound Angle Pose | Hold for 5 breaths | |
| Shoulder Stand Plow | Hold for 5 breaths | |
| Reclining Spinal Twist | Hold for 5 breaths | Both sides |
| Fish Pose | Hold for 5 breaths | |
| Corpse Pose | Hold for 5 breaths | |
| Savasana Cool Down | Hold for 5 breaths | |

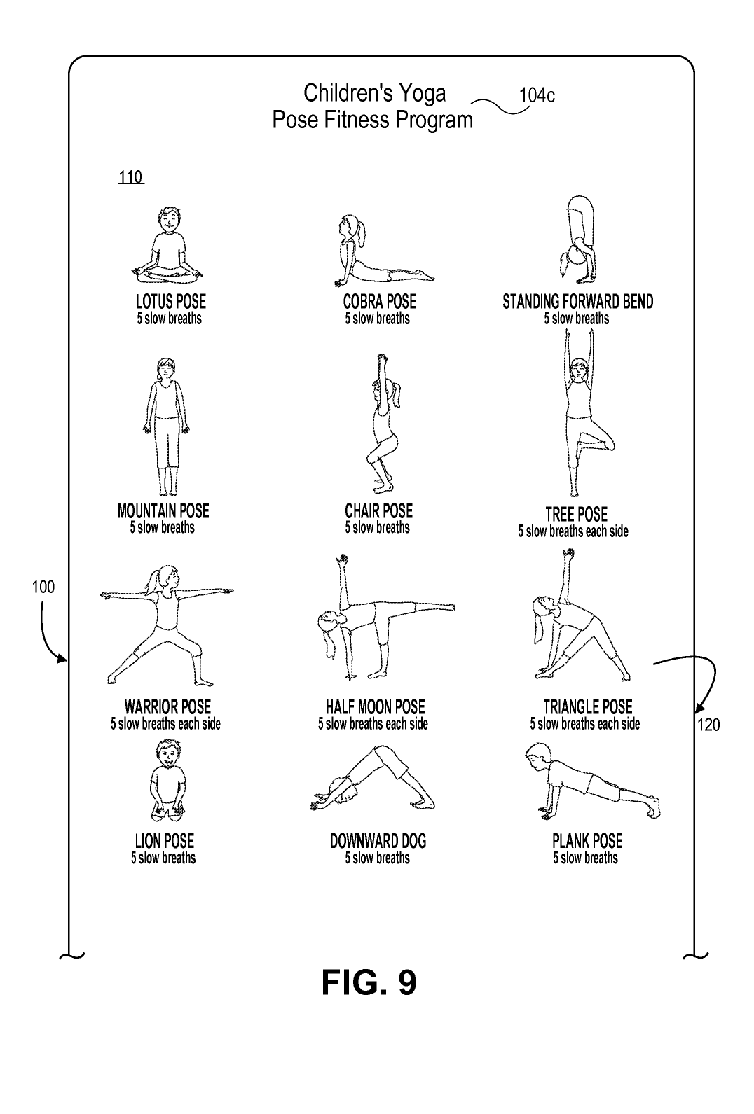

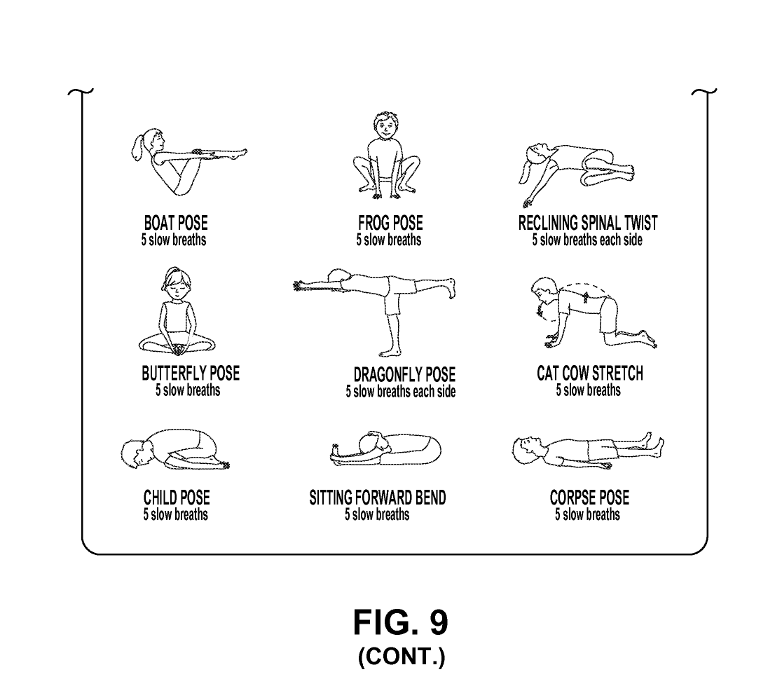

FIG. 9 is a top plan view of a fitness mat having a children's yoga pose fitness program displayed thereon in accordance with another example embodiment. FIG. 9 is similar to FIGS. 7 and 8; therefore only the differences are discussed in detail hereafter. Children's yoga pose fitness programs 104c is shown as a plurality of serially-arranged poses on fitness mat 100. Table 6 details the various exercises, timing and repetitions displayed in the children's yoga pose fitness programs 104c, it being understood that such are only exemplary of various possible exercises which could be incorporated therein.

TABLE 6
CHILDREN'S YOGA POSE FITNESS PROGRAM

| Exercise Name | Time | Repetitions |
|---|---|---|
| Lotus Pose | 5 slow breaths | |
| Cobra Pose | 5 slow breaths | |
| Standing Forward Bend | 5 slow breaths | |
| Mountain Pose | 5 slow breaths | |
| Chair Pose | 5 slow breaths | |
| Tree Pose | 5 slow breaths | Each side |
| Warrior Pose | 5 slow breaths | Each side |
| Half Moon | 5 slow breaths | Each side |
| Triangle Pose | 5 slow breaths | Each side |
| Lion Pose | 5 slow breaths | |
| Downward Dog | 5 slow breaths | |
| Plank Pose | 5 slow breaths | |
| Boat Pose | 5 slow breaths | |
| Frog Pose | 5 slow jumps | |
| Reclining Spinal Twist | 5 slow breaths | Each side |
| Butterfly Pose | 5 slow breaths | |
| Dragonfly Pose | 5 slow breaths | Each side |
| Cat Cow Stretch | 5 slow breaths | |
| Child Pose | 5 slow breaths | |
| Sitting Forward Bend | 5 slow breaths | |
| Corpse Pose | 5 slow breaths | |

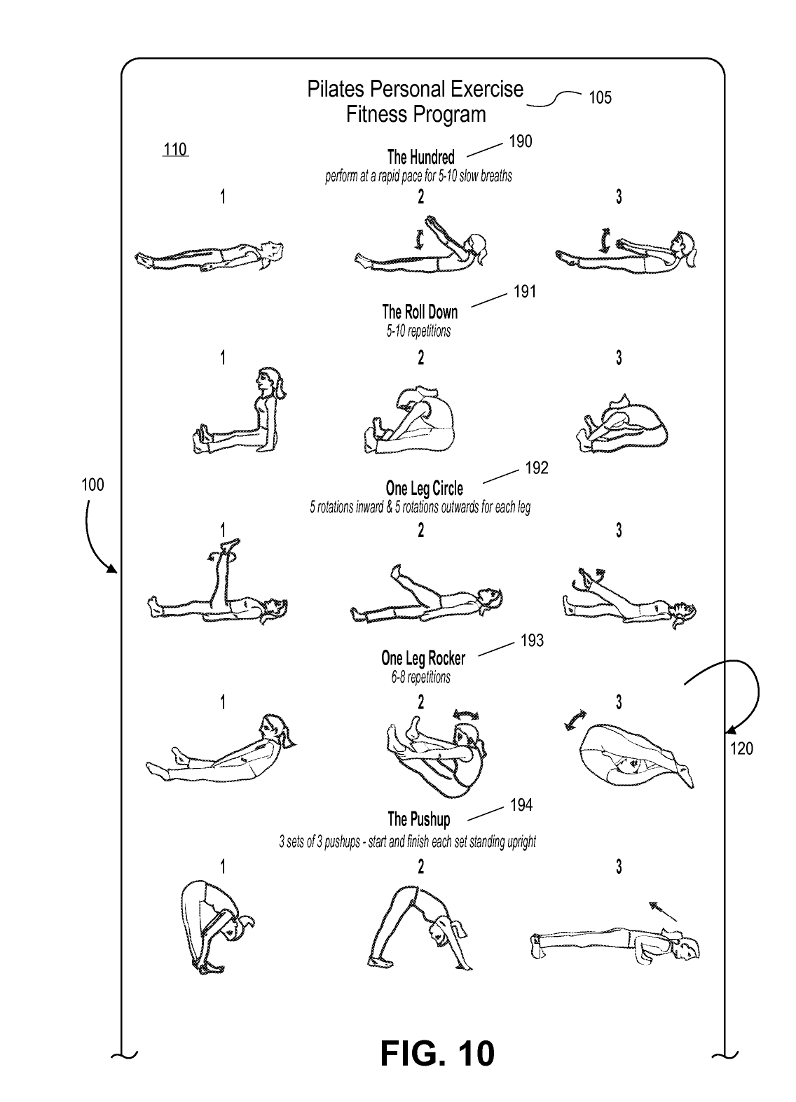

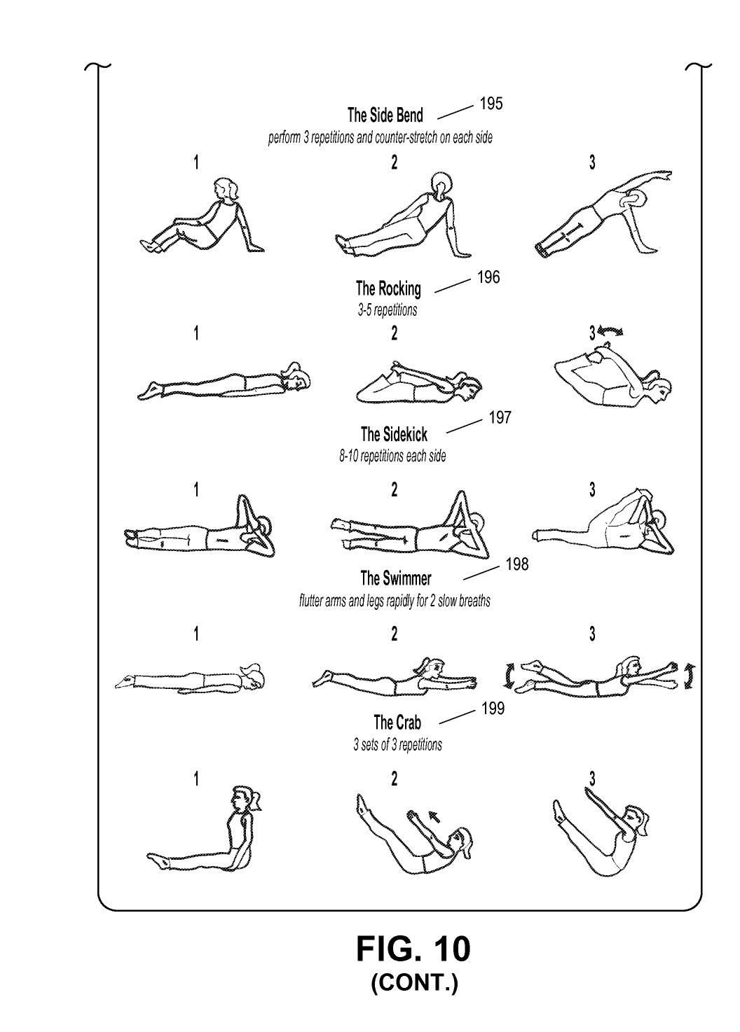

FIG. 10 is a top plan view of a fitness mat having a Pilates personal exercise fitness program displayed thereon in accordance with another example embodiment. As the structural characteristics of fitness mat 100 in FIG. 9 are substantially identical to as described in FIGS. 1-4, only the differences are discussed in detail. Referring to FIG. 10, there is shown a plurality of different exercises displayed on fitness mat 100 in series as part of a Pilates personal stretch fitness program 105. Unlike the previous example embodiments, the Pilates personal exercise fitness program 105 illustrates exercises 190 to 199 on a step-by-step basis, providing intermediary steps. As an example, each of the ten exercises 190 to 199 is broken down into three intermediate steps to assist the exerciser in perfecting the exercise technique.

Table 7 details the various exercises, timing and repetitions displayed in the Pilates personal exercise fitness program 105 as shown in FIG. 10; it being understood that such are only exemplary of various possible exercises which could be incorporated therein.

TABLE 7
PILATES PERSONAL EXERCISE FITNESS PROGRAM

| Exercise Name | Time | | Repetitions |
|---|---|---|---|
| The Hundred | 5-10 | slow breaths | max in breath rate |
| The Roll Down | | | 5-10 |
| One Leg Circle | | | 5 inward/5 outward |
| | | | rotations per leg |
| The Open Leg Rocker | | | 6-8 |
| The Pushup | | | 3 sets of 3 |
| The Side Bend | | | 3 w/counter stretch |
| | | | on each side |
| The Rocking | | | 3-5 |
| The Sidekick | | | 8-10, per side |
| The Swimmer | 2 | slow breaths | |
| The Crab | | | 3 sets of 3 |

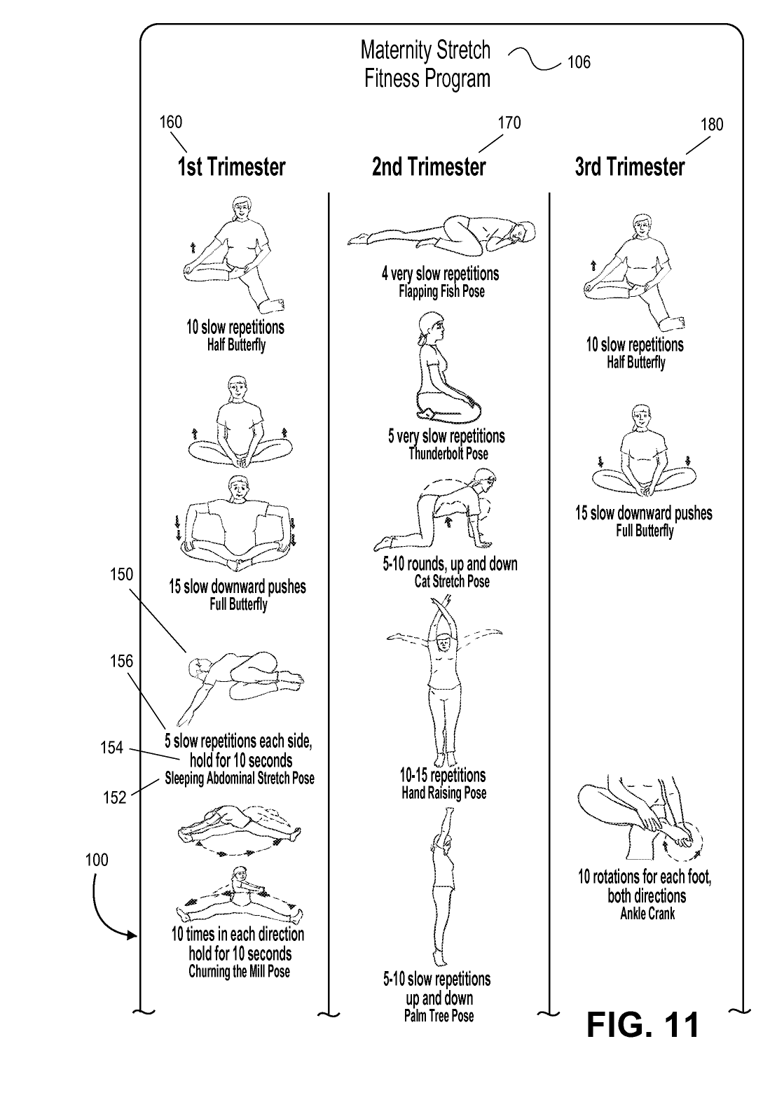

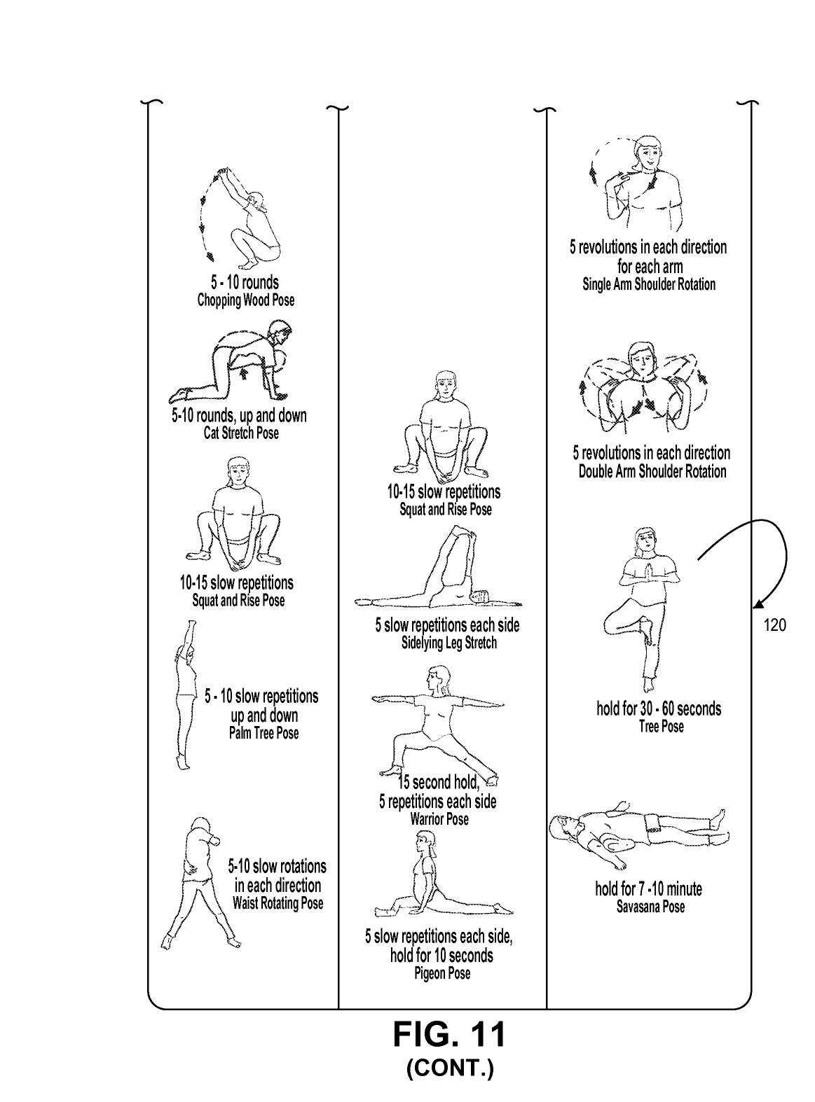

FIG. 11 is a top plan view of a fitness mat having a maternity stretch fitness program displayed thereon in accordance with another example embodiment. In FIG. 11, the maternity stretch fitness program 106 is broken down into three distinct fitness programs, a 1^{st} trimester program 160, 2^{nd} trimester program 170 and 3^{rd} trimester program 180. Similar to the previous example embodiments, one or more of the exercises 150 are accompanied by various combinations of name text 152 with time text 154 and/or repetition text 156.

Table 8 details the various exercises, timing and repetitions displayed in the maternity stretch fitness program 106 as shown in FIG. 11; it being understood that such are only exemplary of various possible exercises which could be incorporated therein.

TABLE 8
MATERNITY STRETCH FITNESS PROGRAM

| | | |
|---|---|---|
| Exercise Name | Time | Repetitions |

First Trimester Program

| | | | |
|---|---|---|---|
| Half Butterfly | | | 10 (slow) |
| Full Butterfly | | | 15 (slow downward push) |
| Sleeping Abdominal Stretch Pose | 10 | second hold | 5 per side (slow) |
| Churning the Mill Pose | 10 | second hold | 10 each direction |
| Chopping Wood Pose | | | 5-10 |
| Cat Stretch Pose | | | 5-10, up/down |
| Squat and Rise Pose | | | 10-15 (slow) |
| Palm Tree Pose | | | 5-10 (slow), up/down |
| Waist Rotating Pose | | | 5-10 (slow rotations), each way |

Second Trimester Program

| | | | |
|---|---|---|---|
| Flapping Fish Pose | | | 4 (very slow) |
| Thunderbolt Pose | | | 5 (very slow) |
| Cat Stretch Pose | | | 5-10, up/down |
| Hand Raising Pose | | | 10-15 |
| Palm Tree Pose | | | 5-10 (slow), up/down |
| Squat and Rise Pose | | | 10-15 (slow) |
| Sidelying Leg Stretch | | | 5 per side (slow) |
| Warrior Pose | 15 | second hold | 5 per side |
| Pigeon Pose | 10 | second hold | 5 per side (slow) |

Third Trimester Program

| | | | |
|---|---|---|---|
| Half Butterfly | | | 10 (slow) |
| Full Butterfly | | | 15 slow downward pushes |
| Ankle Crank | | | 10 rotations each foot, both directions |
| Single Arm Shoulder Rotation | | | 5 revs each direction per arm |
| Double Arm Shoulder Rotation | | | 5 revolutions each direction |
| Tree Pose | 30-60 | seconds | |
| Savasana Pose | 7-10 | minutes | |

The fitness mat 100 as embodied in any of the aforementioned FIGS. 1-11 may be manufactured in various colors in both male and female figurines, as desired. Although the example embodiments above have described a fitness mat 100 configured for certain fitness programs with specific movements with desired repetitions and durations of movement, the fitness mat 100 may display any number of movements, repetitions, or durations without deviating from the example embodiments.

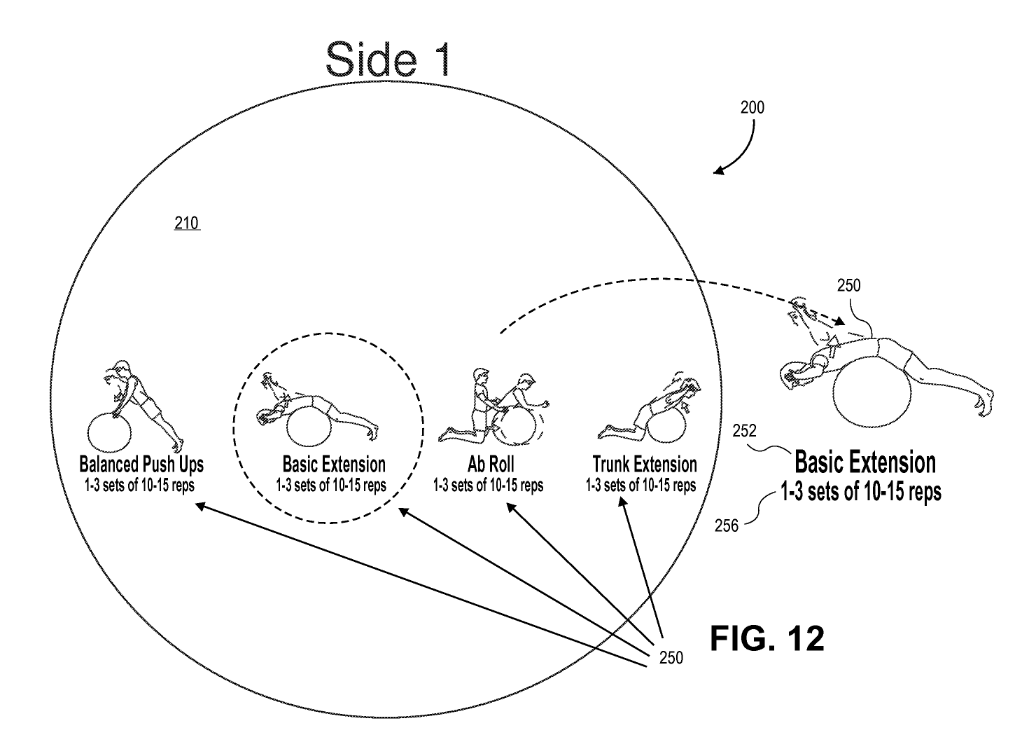

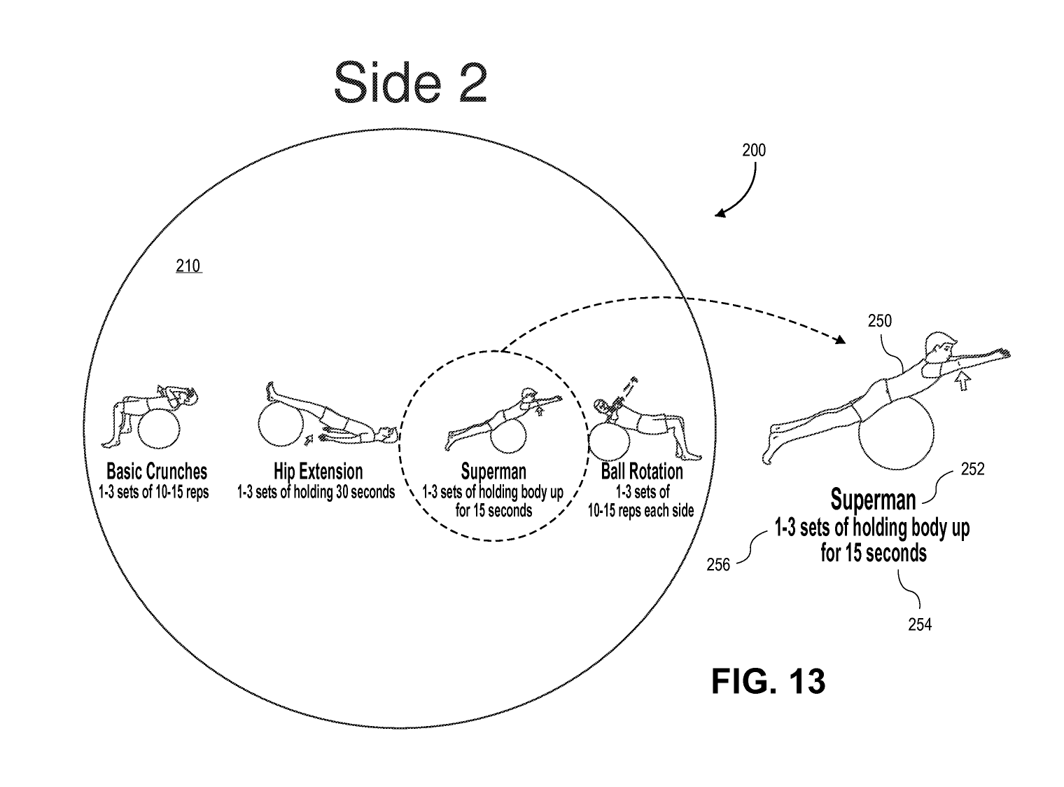

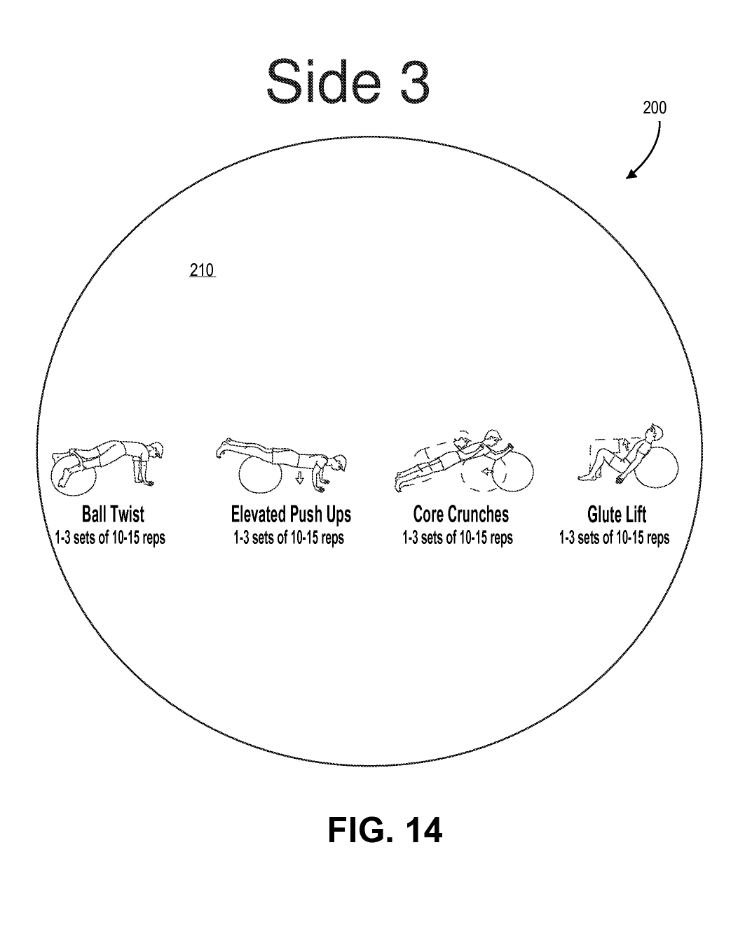

FIGS. 12 to 14 are side elevation views of a fitness ball having a fitness program displayed thereon in accordance with another example embodiment. Referring to FIGS. 12 to 14, there is shown three (3) sides of an inflatable fitness ball 200 which may be used in performing various different exercises 250 which are visibly displayed thereon, such as a physical exercise, stretch, pose, etc. The three sides are shown to denote that the exercises 250 may be arranged in series in a row for display on an outer surface 210 of the ball 200, it being understood that the exercises 250 could be displayed in rows or in any other orientation on the outer surface 210. As can be seen in FIGS. 12-14, the male (or female) figurines in each of the exercises 250 show some action between a person and an exercise fitness ball.

Similar to as described in the previous example embodiments, the exercises 250 include indicia related to the number of repetitions to performed for the exercises, the amount of time to perform the exercises, and the name of the exercises. For example, a given exercise 250 includes name text 252 and one or more of time text 254 and repetition text 256 printed beneath the displayed exercise 250, for example.

The exercises 250 may be displayed in series as a complete fitness program around the circumference of the ball 200, in either a male or female figurine. Although the exercises 250 on the outer surface 210 of fitness ball 200 show specific movements with desired repetitions and durations of movement, the fitness ball 200 may display any number of movements, repetitions, or durations without deviating from the example embodiments. The indicia (inclusive of exercise figurines and text) may be printed on the fitness ball 200 by any means within the skill of the art.

Table 9 details the various exercises, timing and repetitions displayed on the fitness ball 200 as shown in FIGS. 12-14; it being understood that such are only exemplary of various possible exercises which could be displayed thereon.

TABLE 9
SUMMARY OF EXERCISES ON FITNESS BALL

| Exercise Name | Time | Repetitions |
|---|---|---|
| Balanced Push Ups | | 10-15, 1-3 sets |
| Back Extension | | 10-15, 1-3 sets |
| Ab Roll | | 10-15, 1-3 sets |
| Trunk Extension | | 10-15, 1-3 sets |
| Basic Crunches | | 10-15, 1-3 sets |
| Hip Extension | 30 second hold | 1-3 sets |
| Superman | 15 second hold | 1-3 sets |
| Ball Rotation | | 10-15 per side, 1-3 sets |
| Ball Twist | | 10-15, 1-3 sets |
| Elevated Push Ups | | 10-15, 1-3 sets |
| Core Crunches | | 10-15, 1-3 sets |
| Glute Lift | | 10-15, 1-3 sets |

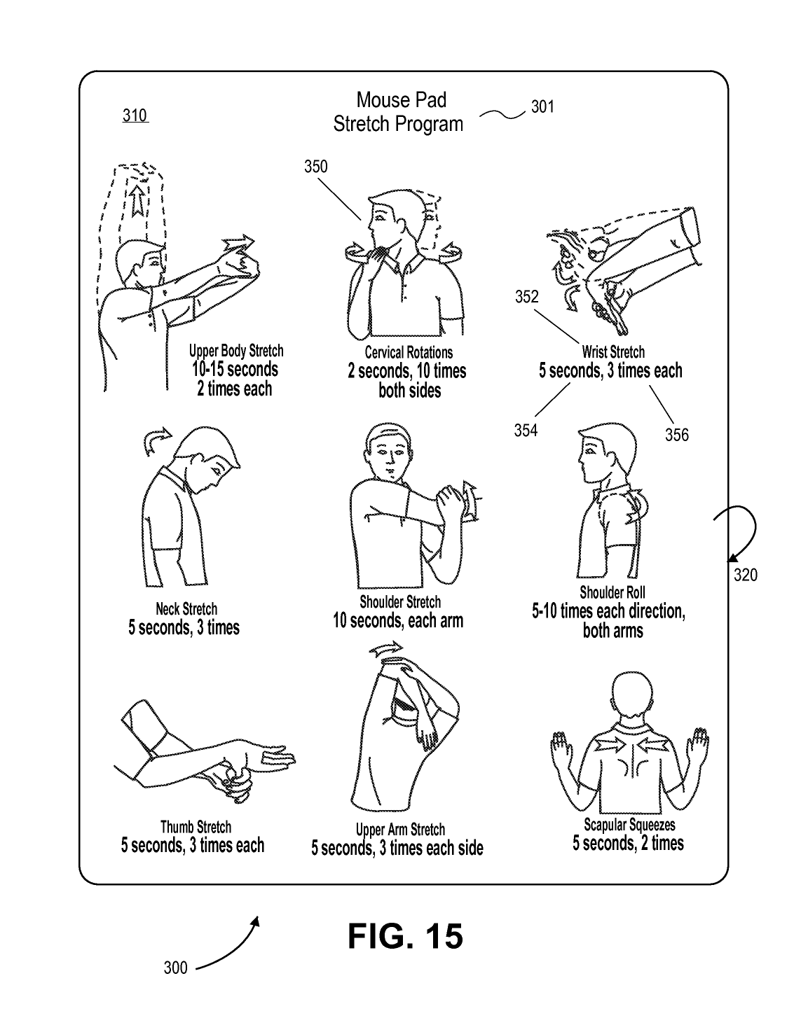

FIG. 15 is a top plan view of a mouse pad having a stretch program displayed thereon in accordance with another example embodiment. Referring to FIG. 15, the mouse pad 300 includes a generally flat, square structure having a top surface 310, bottom surface 320 and a given thickness. As shown, top surface 310 has a plurality of indicia and/or markings thereon to facilitate performance of various exercises and/or stretch routines.

The mouse pad 300 includes indicia, particularly a plurality of different exercises 350 visibly displayed thereon in series format to represent a stretch program 301. Although exercises 350 are shown only on top surface 310, the exercises 350 and associated indicia/markings may be displayed or printed additionally on bottom surface 320, or only on bottom surface 320, for example.

Similar to as described in the previous example embodiments, the exercises 350 include indicia related to the number of repetitions to performed for the exercises, the amount of time to perform the exercises, and the name of the exercises. For example, a given exercise 350 includes name text 352 and one or more of time text 354 and repetition text 356 printed beneath the displayed exercise 350, for example.

Somewhat similar to as described in FIGS. 6 and 11, multiple different fitness programs could be printed or displayed on the mouse pad 300, such as one on top surface 310 and another on bottom surface 320. Although the exercises 350 on mouse pad 300 show specific movements with desired repetitions and durations of movement, the mouse pad 300 may display any number of movements, repetitions, or durations without deviating from the example embodiments. The indicia (inclusive of exercise figurines and text) may be printed on the mouse pad 300 by any means within the skill of the art.

Table 10 details the various exercises, timing and repetitions displayed in the stretch program 301 as shown in FIG. 15; it being understood that such are only exemplary of various possible exercises which could be incorporated therein.

TABLE 10
STRETCH PROGRAM

| Exercise Name | Time | | Repetitions |
|---|---|---|---|
| Upper Body Stretch | 10-15 | seconds | 2, each direction |
| Cervical Rotations | 2 | seconds | 10, both sides |
| Wrist Stretch | 5 | seconds | 3, each direction |
| Neck Stretch | 5 | seconds | 3 |
| Shoulder Stretch | 10 | seconds | each arm |
| Shoulder Roll | | | 5-10, each direction, each arm |
| Thumb Stretch | 5 | seconds | 3, each thumb |
| Upper Arm Stretch | 5 | seconds | 3, each side |
| Scapular Squeezes | 5 | seconds | 2 |

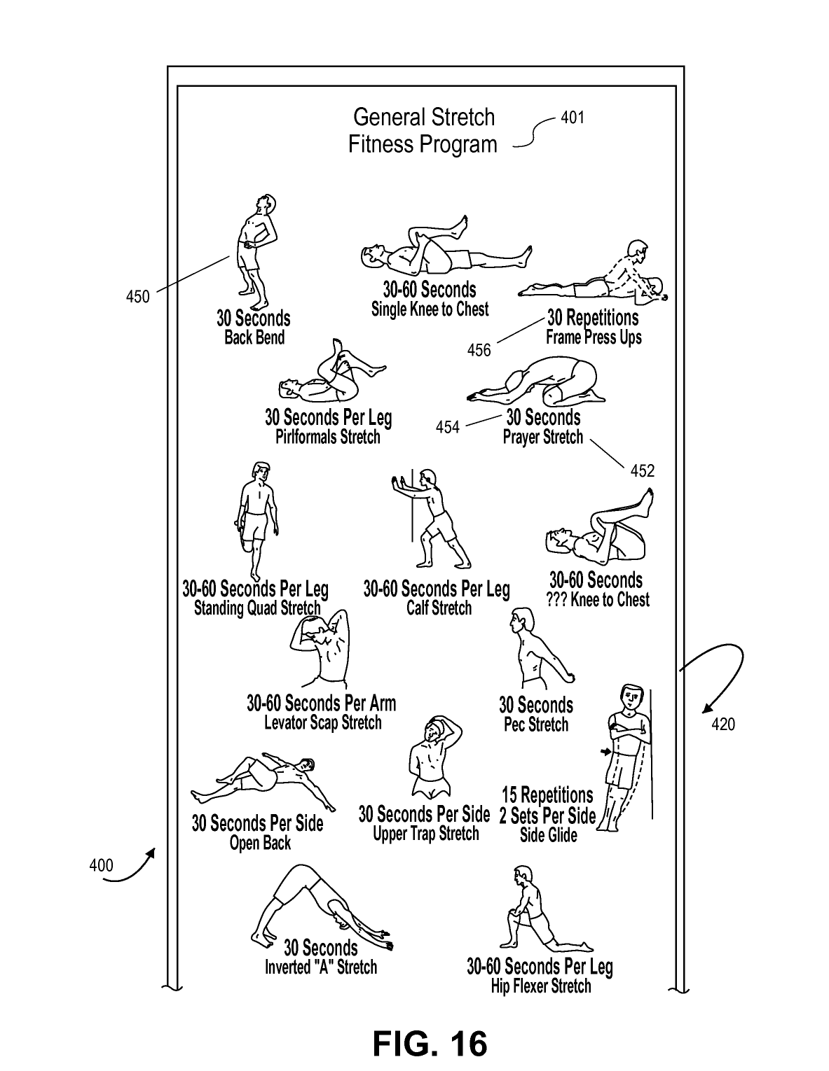

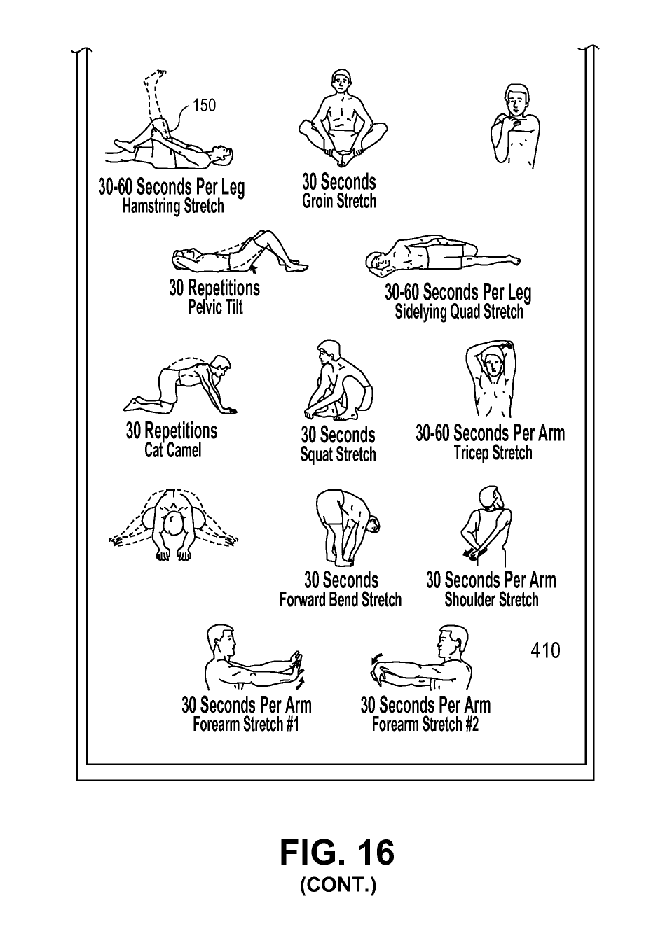

FIG. 16 is a top plan view of a training towel having a general stretch program displayed thereon in accordance with another example embodiment. As the exercises and indicia of the towel 400 are identical to that described in FIGS. 1-4, only the differences are discussed in detail. Referring to FIG. 16, there is shown a training towel 400 which may be used in performing various different exercises 450 that are visibly displayed thereon, such as a physical exercise, stretch, pose, etc. The towel 400 may be composed of a suitable cotton or terry cloth, or a combination of terry cloth made with filaments of one or more of cotton, polyester, bamboo, polyimide, polyurethane, and a microfiber for example. Alternatively, towel 400 may be made of Narcote™, a microfiber, a sponge-like material, chamois, 100% natural fiber material such as bamboo, or other equivalent type material.

The exercises, timing and repetitions displayed in the general stretch fitness program 401 as shown in FIG. 16 are the same as shown in FIG. 1 and Table 1; it being understood that such are only exemplary of various possible exercises which could be incorporated therein.

Similar to as described in the previous example embodiments, the exercises 350 include indicia related to the number of repetitions to performed for the exercises, the amount of time to perform the exercises, and the name of the exercises. For example, a given exercise 350 includes name text 352 and one or more of time text 354 and repetition text 356 printed beneath the displayed exercise 350, for example.

Somewhat similar to as described in FIGS. 6 and 11, multiple different fitness programs could be printed or displayed on the towel 400, such as one on top surface 410 and another on bottom surface 420. Although the exercises 450 show specific movements with desired repetitions and durations of movement, the towel 400 may display any number of movements, repetitions, or durations without deviating from the example embodiments. The indicia (inclusive of exercise figurines and text) may be printed on the towel 400 by any means within the skill of the art.

The example embodiments being thus described, it will be obvious that the same may be varied in many ways. Such variations are not to be regarded as departure from the example embodiments, and all such modifications as would be obvious to one skilled in the art are intended to be included herein.

What is claimed is:

1. A portable article with indicia displayed thereon for use in exercising, comprising:
a structure, the structure having a surface, the surface including a plurality of different exercises visibly displayed thereon, wherein
indicia is displayed on the surface beneath each of the different exercises to facilitate exercise, the displayed indicia including text related to a name of each of the exercises and a time period to perform one or more of the exercises.

2. The article of claim 1, wherein the exercises comprise a plurality of different physical exercises, stretching exercises and yoga poses.

3. The article of claim 2, wherein one or more of the displayed exercises further including text related to a number of repetitions to perform.

4. The article of claim 1, wherein the structure comprises one of a fitness mat, a fitness ball, a mouse pad and a towel.

5. The article of claim 1, wherein
the exercises are displayed in series as a fitness program, and
more than one fitness program is displayed on the structure.

6. The article of claim 5, wherein
the structure has a top surface and a bottom surface, and
a first fitness program is displayed on the top surface and a second fitness program is displayed on the bottom surface.

7. A portable article with indicia displayed thereon for use in exercising, comprising:
a structure, the structure having a surface including a plurality of different exercises visibly displayed thereon, wherein
indicia is displayed on the surface beneath each of the different exercises to facilitate exercise, the displayed indicia including text related to a name of each of the exercises, one or more of the exercises further including text related to a number of repetitions to perform.

8. The article of claim 7, wherein the displayed indicia further includes text related to a time period to perform one or more of the exercises.

9. The article of claim 7, wherein the structure comprises one of a fitness mat, a fitness ball, a mouse pad and a towel.

10. A fitness mat for use in performing an exercise, comprising:
a mat of a generally flat structure having a top surface, bottom surface and a thickness, a major longitudinal axis and a minor longitudinal axis orthogonal to the major longitudinal axis, wherein
one of the top and bottom surfaces includes a plurality of different exercises visibly displayed thereon embodied by human figurines demonstrating how to perform the exercises, and
indicia is displayed beneath each of the human figurines, the displayed indicia including text related to a name of each of the exercises and a time period to perform one or more of the exercises.

11. The mat of claim 10, wherein the displayed exercises include a fitness program selected from the group comprising a general stretch fitness program, a back stretch fitness program, a golf stretch fitness program, a yoga pose fitness program, a Pilates personal fitness program, and a maternity stretch fitness program.

12. The mat of claim 11, wherein one or more of the displayed exercises in the group of fitness programs further includes text related to a number of repetitions to perform.

13. The mat of claim 10, wherein the exercises comprise a plurality of different physical exercises, stretching exercises and yoga poses.

14. A fitness mat for use in performing an exercise, comprising:
a mat of a generally flat structure having a top surface, bottom surface and a thickness, a major longitudinal axis and a minor longitudinal axis orthogonal to the major longitudinal axis, wherein
one of the top and bottom surfaces includes a plurality of different exercises visibly displayed thereon embodied by human figurines demonstrating how to perform the exercises, and
indicia is displayed beneath each of the human figurines, the displayed indicia including text related to a name of each of the exercises, one or more of the exercises further including text related to a number of repetitions to perform.

15. The mat of claim 14, wherein the displayed indicia further includes text related to a time period to perform one or more of the exercises.

16. The mat of claim 14, wherein the displayed exercises include a fitness program selected from the group comprising a general stretch fitness program, a back stretch fitness program, a golf stretch fitness program, a yoga pose fitness program, a palates personal fitness program, and a maternity stretch fitness program.

17. A fitness ball for use in performing an exercise, comprising:
an inflatable ball of a spherical shape having an outer surface, wherein
the outer surface includes a plurality of different exercises visibly displayed thereon embodied by human figurines demonstrating how to perform the exercises, and
indicia is displayed beneath each of the human figurines, the displayed indicia including text related to a name of each of the exercises and a time period to perform one or more of the exercises.

18. The ball of claim 17, wherein the displayed exercises includes the human figurine performing an exercise action with a fitness ball on the outer surface.

19. The ball of claim 18, wherein one or more of the displayed exercises further includes text related to a number of repetitions to perform.

20. A fitness ball for use in performing an exercise, comprising:
an inflatable ball of a spherical shape having an outer surface, wherein
the outer surface includes a plurality of different exercises visibly displayed thereon embodied by human figurines demonstrating how to perform the exercises, and
indicia is displayed beneath each of the human figurines, the displayed indicia including text related to a name of each of the exercises, one or more of the exercises further including text related to a number of repetitions to perform.

21. The mat of claim 20, wherein the displayed indicia further includes text related to a time period to perform one or more of the exercises.

22. A mouse pad for use in performing an exercise, comprising:
a pad of a generally flat, square structure having a top surface and bottom surface,
wherein one of the top and bottom surfaces includes a plurality of different exercises visibly displayed thereon embodied by human figurines demonstrating how to perform the exercises.

23. The mouse pad of claim 22, wherein each of the human figurines include indicia there beneath including one or more of a number of repetitions to perform the exercise, direction of movement, an amount of time to perform the exercise, and a name of each exercise.

24. The mouse pad of claim 22, wherein the exercises comprise a plurality of different stretching exercises.
